(19) United States
(12) Patent Application Publication
(10) Pub. No.: US 2007/0255676 A1
(43) Pub. Date: Nov. 1, 2007

(54) Methods and apparatus for performing tree-based processing using multi-level memory storage

(76) Inventors: David Allen Brown, Austin, TX (US); Robert A. Corley, Cedar Park, TX (US); David P. Sonnier, Austin, TX (US)

Correspondence Address: RYAN, MASON & LEWIS, LLP, 90 FOREST AVENUE, LOCUST VALLEY, NY, 11560, US

(21) Appl. No.: 11/412,851

(22) Filed: Apr. 27, 2006

(51) Int. Cl. G06F 17/30

(52) U.S. Cl. 707/1

(57) ABSTRACT

Improved techniques for performing tree-based processing associated with a network processor or other type of processor are disclosed. By way of example, a method of performing a traversal of a tree structure includes the following steps. A first portion of data of a tree structure to be traversed is stored in a first memory level. A second portion of data of the tree structure to be traversed is stored in a second memory level. At least a third portion of data of the tree structure to be traversed is stored in at least a third memory level. In response to receipt of an input search object, a processor traverses one or more of the portions of the tree structure respectively stored in the memory levels to determine one or more matches between the tree data stored in the memory levels and the input search object. The processor, the first memory level, and the second memory level are implemented on one integrated circuit, and the third memory level is implemented external to the integrated circuit.

### CROSS REFERENCE TO RELATED APPLICATION

The present application relates to co-pending U.S. patent application identified as Ser. No. 10/037,040, filed on Dec. 21, 2001, and entitled “Method of Improving the Lookup Performance of Tree-type Knowledge Base Searches,” the disclosure of which is incorporated by reference herein.

### FIELD OF THE INVENTION

The present invention relates generally to packet processing systems, and more particularly to a network processor or other type of processor configured for use in performing tree-based processing.

### BACKGROUND OF THE INVENTION

A network processor generally controls the flow of packets between a physical transmission medium, such as a physical layer portion of, e.g., an asynchronous transfer mode (ATM) network or synchronous optical network (SONET), and a switch fabric in a router or other type of packet switch. Such routers and switches generally include multiple network processors, e.g., arranged in the form of an array of line or port cards with one or more of the processors associated with each of the cards.

In performing packet processing operations such as classifying, routing or switching, the network processor typically must examine at least a portion of each packet. A packet is generally made of a string of binary bits. The amount of each packet that must be examined is dependent upon its associated network communication protocols, enabled options, and other similar factors.

More specifically, in a packet classification operation, the network processor typically utilizes a tree traversal process to determine various characteristics associated with each packet, i.e., to classify the input data according to one or more data attributes. The tree structure is also known as a knowledge base. The tree structure typically has a root portion where the processing begins, intermediate branches, and finally a plurality of leaves, where the final decisions or matches occur. Thus, each node of the tree is an entry or a decision point, and such entries or decision points are interconnected by branches. An instruction or bit pattern resides at each decision point for analyzing the input bit pattern (also referred to as the search object) and in response thereto for sending the bit pattern to the next appropriate decision point.

Since the data is presented in the form of binary bits, the processor compares groups of the input bits with known bit patterns, represented by entries in the tree structure. A match between the group of input bits and the bits at a tree entry directs the process to the next associated entry in the tree. The matching processes progress through a path of the tree until the end is reached, at which point the input bits have been characterized. Because a large number of bits must be classified in a data network, these trees can require many megabits of memory storage capacity.

The classification process finds many uses in a data communications network. The input data packets can be classified based on a priority indicator within the packet, using a tree structure where the decision paths represent the different network priority levels. Once the priority level is determined for each packet, based on a match between the input bits and the tree bits representing the available network priority levels, then the packets can be processed in priority order. As a result, time sensitive packets (e.g., those carrying video-conference data) are processed before time insensitive packets (e.g., a file transfer protocol (FTP) data transfer).

Other packet classifications processes determine the source of the packet (for instance, so that a firewall can block all data from one or more sources), examine the packet protocol to determine which web server can best service the data, or determine network customer billing information. Information required for the reassembly of packets that have been broken up into data blocks for processing through a network processor can also be determined by a classification engine that examines certain fields in the data blocks. Packets can also be classified according to their destination address so that packets can be grouped together according to the next device they will encounter as they traverse the communications medium.

One important attribute of any tree processing scheme is the worst case time required to complete a traversal. Generally, such tree processing schemes are implemented in a plurality of steps or cycles that each take a predetermined amount of time to complete. Thus, the maximum time to complete a traversal of the tree is generally reduced by minimizing the time spent at each step of the process.

Another important attribute of any tree processing scheme is the processing bandwidth associated with the processor. The problem is that the processor has to fetch instructions associated with the tree from memory, and is thus limited by the bandwidth of the memory in which such instructions are stored.

Accordingly, a need exists for improved techniques for performing tree-based processing associated with a network processor or other type of processor, wherein the improved techniques serve to reduce the time required to perform the processing.

### SUMMARY OF THE INVENTION

Principles of the invention provide improved techniques for performing tree-based processing associated with a network processor or other type of processor. Advantageously, such improved techniques serve to reduce the time required to perform the tree-based processing.

By way of example, in one aspect of the invention, a method of performing a traversal of a tree structure includes the following steps. A first portion of data of a tree structure to be traversed is stored in a first memory level. A second portion of data of the tree structure to be traversed is stored in a second memory level. At least a third portion of data of the tree structure to be traversed is stored in at least a third memory level. In response to receipt of an input search object, a processor traverses one or more of the portions of the tree structure respectively stored in the memory levels to determine one or more matches between the tree data stored in the memory levels and the input search object. The processor, the first memory level, and the second memory level are implemented on one integrated circuit, and the third memory level is implemented external to the integrated circuit.

The processor may include two or more engines, and the first memory level includes two or more memory elements, wherein the two or more memory elements are respectively dedicated to the two or more engines. The step of storing the first portion of the tree structure in the first memory level may include storing a copy of the first portion of data of the tree structure in each of the two or more memory elements of the first memory level. A first one of the two or more engines may access one or more of the portions of the tree structure respectively stored in the memory levels, including its dedicated memory element associated with the first memory level, to determine one or more matches between the stored tree data and at least a portion of the input search object. Substantially simultaneous with the first one of the engines, a second one of the two or more engines may access one or more of the portions of the tree structure respectively stored in the memory levels, including its dedicated memory element associated with the first memory level, to determine one or more matches between the stored tree data and at least a portion of the input search object. The portion of the input search object processed by the first engine may be different than the portion of the input search object processed by the second engine. Alternatively, the portion of the input search object processed by the first engine may be the same as the portion of the input search object processed by the second engine. Still further, one engine may process one input search object while another engine processes another input search object.

An access time associated with the first memory level may be less than an access time associated with at least one of the other memory levels. An access time associated with the third memory level may be greater than an access time associated with at least one of the other memory levels.

In one embodiment, the processor may include a network processor, the input search object may include packet data, and the tree structure may include data used for classifying at least a portion of the packet data.

In another aspect of the invention, apparatus for performing a traversal of a tree structure includes: a first memory level for storing a first portion of data of a tree structure to be traversed; a second memory level for storing a second portion of data of the tree structure to be tarversed; at least a third memory level for storing at least a third portion of data of the tree structure to be traversed; and a processor for traversing, in response to receipt of an input search object, one or more of the portions of the tree structure respectively stored in the memory levels to determine one or more matches between the tree data stored in the memory levels and the input search object. The processor, the first memory level, and the second memory level are implemented on one integrated circuit, and the third memory level is implemented external to the integrated circuit.

In a further aspect of the invention, an integrated circuit comprises: a first memory level for storing a first portion of data of a tree structure to be traversed; a second memory level for storing a second portion of data of the tree structure to be traversed; and a processor, wherein the processor is configured to access the first memory level, the second memory level, and at least a third memory level for storing at least a third portion of data of the tree structure to be traversed, wherein the third memory level is remote from the integrated circuit. In response to receipt of an input search object, the processor traverses one or more of the portions of the tree structure respectively stored in the memory levels to determine one or more matches between the tree data stored in the memory levels and the input search object.

These and other objects, features and advantages of the present invention will become apparent from the following detailed description of illustrative embodiments thereof, which is to be read in connection with the accompanying drawings.

### BRIEF DESCRIPTION OF THE DRAWINGS

FIG. 1 is a block diagram illustrating a packet processing system in which embodiments of the invention may be implemented.

FIG. 2 is a diagram illustrating a tree structure which may be employed in a classification process performed by a processor, according to an embodiment of the invention.

FIG. 3 is a block diagram illustrating a processor/memory arrangement, according to an embodiment of the invention.

FIG. 4 is a block diagram illustrating a processor/memory arrangement, according to another embodiment of the invention.

### DETAILED DESCRIPTION OF PREFERRED EMBODIMENTS

The present invention will be illustrated below in conjunction with an exemplary tree-based packet classification function performed by a network processor that is part of a packet processing system. It should be understood, however, that the invention is more generally applicable to any processing system in which it is desirable to avoid the drawbacks attributable to the use of existing techniques for performing tree-based processing.

By way of example only, principles of the invention are applicable to packet processors such as those available from Agere Systems Inc. (Allentown, Pa.), e.g., network processors respectively identified as APP350, APP550, and APP650. However, it is to be understood that principles of the invention are not limited to these, or any, particular processors.

It is to be understood that the term “processor” as used herein may be implemented, by way of example and without limitation, utilizing a microprocessor, central processing unit (CPU), digital signal processor (DSP), application-specific integrated circuit (ASIC), or other type of data processing device or processing circuitry, as well as portions and combinations of these and other devices or circuitry.

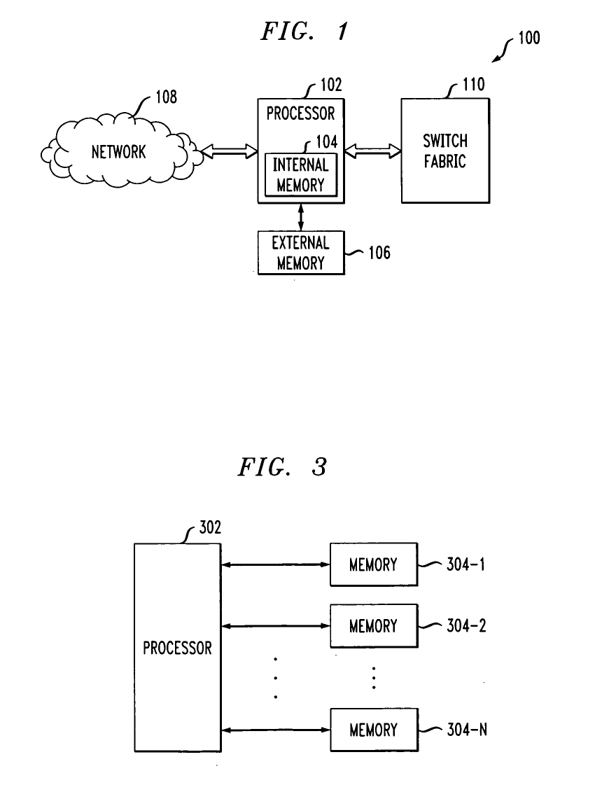

Referring to FIG. 1, an illustrative packet processing system 100 is shown in which embodiments of the invention are implemented. The system 100 includes a network processor 102 having an internal memory 104. The network processor 102 is coupled to an external memory 106 as shown, and is configured to provide an interface between a network 108 from which packets are received and a switch fabric 110 which controls switching of packet data. The processor 102 and its associated external memory 106 may be implemented, e.g., as one or more integrated circuits installed on a line card of a router or switch. In such a configuration, the switch fabric 110 is generally considered to be a part of the router or switch.

It should be understood that the particular arrangement of system elements shown in FIG. 1 is by way of illustrative example only. For example, as previously noted, principles of the invention can be implemented in any type of packet processor, and is not limited to any particular packet processing application.

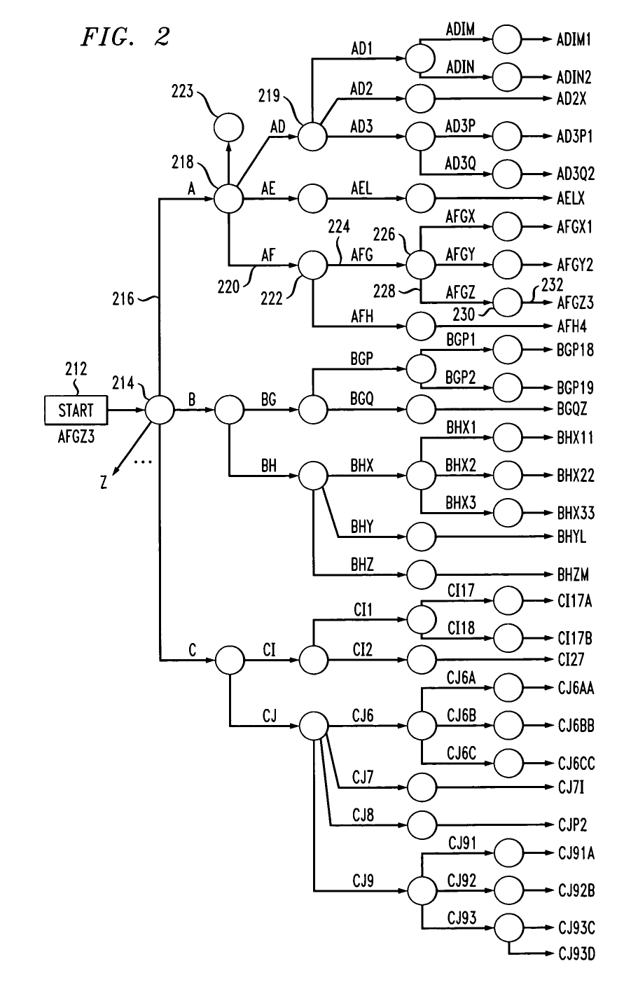

An exemplary tree structure is illustrated in FIG. 2. As mentioned, such tree structures are used in a packet classification process performed by a network processor, e.g., such as shown in FIG. 1. In such a data structure, entries or decision points (nodes) are interconnected by branches (links). An instruction or bit pattern resides at each decision point for analyzing the input bit pattern (search object) and in response thereto for sending the bit pattern to the next appropriate decision point.

The illustrative tree of FIG. 2 has five levels of analysis or entries, as represented by the five columns of vertically aligned nodes, represented by circles. At a start step 212, a five character word or symbol (the search object) is input to the decision tree, for instance, the characters AFGZ3. The most significant characters of the symbol are compared with the tree entries at a decision point 214, and the analysis proceeds along a branch 216, representing the symbol “A,” to a decision point 218. From there, the process proceeds as follows: branch 220, decision point 222, branch 224, decision point 226, branch 228, decision point 230 and finally branch 232, which is commonly referred to as a leaf of the tree. At this leaf, the symbols have been decoded and the appropriate action or decision associated with that leaf is executed.

The decision process at each entry of the tree is executed by using a processor to compare a first number of symbols at the first entry with a first number of the input symbols. The result of the first comparison determines the next branch that the process will follow. The symbols at the second entry are fetched from memory by the processor and a second group of the input symbols are compared with the symbols at the second entry. These alternating fetching and comparing steps are executed as the search object is processed through the tree until a decision entry is reached.

The decision tree, such as that of FIG. 2, is stored in memory associated with the processor (also referred to as program memory). Each node of the tree is an instruction and the fields of each instruction specify the branches (links) of the tree to which the processor is directed, based on the results of the instruction. The process then moves along the indicated branch to the next tree node. Special instructions are included at the leaves, as these represent the end of the decision process and therefore command a specific action at each leaf.

With reference to FIG. 2, the root of the tree is the first node, node 214. Assume the instruction for node 214 is stored at address 0 in the program memory. Further assume that this instruction maps each letter of the alphabet to a node (i.e., there are twenty-six branches from this instruction or node 214). To find the next node for the process, the memory address of the current node (zero in this example) is added to the address offset associated with the matching character. Assume the offset address for the letter A is 10, for B the offset address is 11, for C the offset address is 12, etc. Thus node 218 of FIG. 2 is located at memory address 10 (base address of zero plus A offset address of 10). The path for the letter B leads to memory address 11 and the path for letter C leads to memory location 12. Since the example of FIG. 2 includes only A, B and C as possible matching values, all other letters of the alphabet (D through Z) that are input to the node 214 are directed to memory locations 13 to 35, respectively, and similarly processed.

Since the input object begins with an A, the process is directed to the node 218 (memory location 10), which contains three instructions or three potential pattern matches and a memory address offset associated with each. If the pattern match is D and the offset address for the D branch is 1, the process moves to the memory location 11 or node 219 in FIG. 2. If pattern match is an E and the offset address for the E branch is 2, the process moves to memory location 12. If pattern match is an F and the offset address for the F branch is 3, the process moves to memory location 13, or the node 222 via the link 220. If there is no match at this instruction or node, then the process is directed to an offset address of 4, or node 223, where a leaf with a special instruction is located. For the input symbol presented in FIG. 2 (i.e., AF), the process moves to the node 222 (memory location 13) via the link 220.

Principles of the present invention realize that the tree structure for performing the classification process may be segregated and stored in a plurality of memory elements. This provides many advantages, for example, the processor is provided with parallel and simultaneous access to the levels of the tree structure. In addition, such an arrangement provides more memory bandwidth (and thus increased processing bandwidth) since there are more memory levels in which instructions can be stored.

Accordingly, the tree structure may be partitioned between multiple memory elements, such that, depending on the memory elements chosen (i.e., faster memory on-chip versus slower off-chip memory), different read access times are available. Thus, certain tree entries (i.e., nodes or instructions as discussed above) are accessible faster than others.

For example, lower level branches of the tree can be stored on-chip with the processor thereby reducing the read cycle time for the lower level tree entries. Advantageously, there are fewer lower level tree entries as these appear near the tree root. Therefore, the on-chip storage requirements are considerably less than the storage requirements for the entire tree.

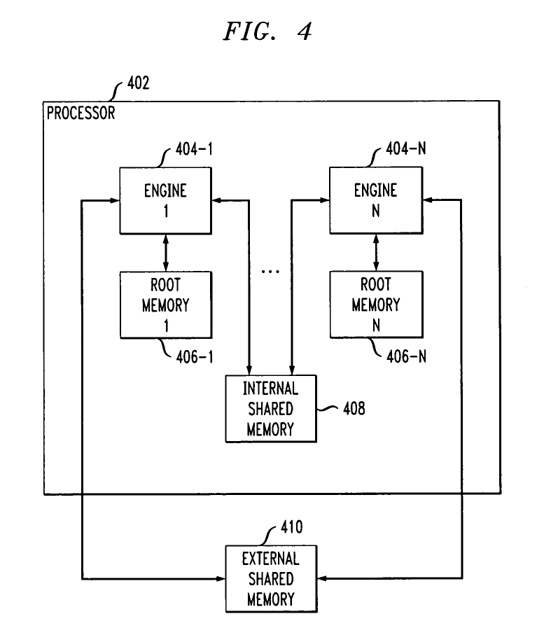

As shown in FIG. 3, a processor 302 communicates bidirectionally with memories 304-1, 302-2, . . . 304-N (where N equals 3 or more), where the instructions representing the levels of a tree structure are stored. For example, where N=3, tree level one (referred to as the root level) of FIG. 2 may be stored in the memory 304-1, tree levels two and three of FIG. 2 may be stored in memory 304-2, and tree levels four and five may be stored in memory 304-3. If memory 304-1 has a faster memory access time than memories 304-2 and 304-3, then the instructions stored in memory 304-1 can be accessed faster than those in memory 304-2 and 304-3. The same is true with respect to memory 304-2, that is, if memory 304-2 has a faster memory access time than memory 304-3, then the instructions stored in memory 304-2 can be accessed faster than those in memory 304-3.

It is known that a significant number of tree traversals are terminated (i.e., reach an end leaf) in the root memory or within one or two levels of the root memory. Simulation and analysis show that about 30% of the search objects being processed are terminated in the root tree memory. Thus, if the tree root is stored in memory 304-1, the process will likely converge faster.

In one embodiment, memory elements 304-1 and 304-2 reside on-chip (part of the processor integrated circuit), while memory element 304-3 (where N=3) resides off-chip (not part of the processor integrated circuit, but rather part of one or more other integrated circuits). For example, with reference back to FIG. 1, memory elements 304-1 and 304-2 may be separate parts of internal memory 104 of processor 102, while memory element 304-3 may be part of external memory 106.

The use of three separate memory structures (or elements) is merely exemplary as additional memory structures can also be employed for storing levels of the tree, i,e., N=4, 5, . . . , etc. Selection of the optimum number of memory elements, the memory access time requirements of each, and the tree levels stored in each memory element can be based on the probability that certain patterns will appear in the incoming data stream. The tree levels or sections of tree levels that are followed by the most probable data patterns are stored in the memory having the fastest access time. For example, all the input patterns traverse the lower levels of the tree, thus these lower levels can be stored within a memory having a fast read cycle time to speed up the tree analysis process. In addition, more memory levels may be added to provide further memory bandwidth improvement, depending on the memory bandwidth requirement of the particular application.

Principles of the present invention can also be applied to parallel processing of a tree structure. See FIG. 4 where processor 402 includes multiple processing engines 404-1 through 404-N, where N equals 2 or more. By way of example only, it is to be understood that a processing engine may be a functional part of the processor that handles a particular portion of the classification process. Alternatively, each engine can perform the same function on a different portion of data. Nonetheless, each engine can perform different or identical functions using the same tree structure. Each engine has a root memory 406-1 . . . 406-N, respectively, that resides on the processor integrated circuit (on-chip), for storing respective identical copies of lower level tree branches. Further, a shared memory 408 resides on-chip (internal shared memory) for storing a single copy of intermediate level tree branches, and a shared memory 410 resides off-chip (external shared memory) for storing a single copy of higher level tree branches. Alternatively, depending on the type of external memory used, multiple copies of the higher level branches can be stored in the shared memory 410.

Advantageously, it is to be appreciated that the bandwidth of any memory level (internal or external memory) can be increased by having multiple copies/instances of that level of memory. Thus, the memory level including shared memory 408 can be configured to have multiple elements such as is done with the first (root) memory level. The external memory level can also be configured in this manner.

For a tree such as the one shown in FIG. 2, segregation of the levels between memories may be done in a manner similar to that in the processor/memory arrangement of FIG. 3. Also, with reference back to FIG. 1, root memories 406-1 . . . 406-N and internal shared memory 408 may be separate parts of internal memory 104 of processor 102, while external shared memory 410 may be part of external memory 106.

Thus, according to the embodiment of FIG. 4, each engine can access its respective root memory (406) for executing the tree traversal, then access the internal shared memory (408) when the intermediate tree branches are encountered, and then access the external shared memory (410) when the higher tree branches are encountered. As shown in the embodiment of FIG. 4, the root memories 406 and the shared memory 408 are located on the same integrated circuit device as the engines 404, thus providing faster access times than the external memory 410.

The embodiment of FIG. 4 may be considered a multi-threaded architecture since it allows the network processor 402 to execute a plurality of simultaneous accesses throughout one or more tree traversals. For example, the processor can fetch the tree structure information from the root memories in parallel, since each memory is accessible through a different thread (engine), thereby reducing the time required to execute the classification process.

Advantageously, since there are fewer tree branches at the root level, the capacity requirements for a root memory 406 are lower than the capacity requirements for an equivalent number of upper level branches. As explained above, the latter are stored in internal shared memory 408 and external shared memory 410. While internal shared memory 408 can run at the same speed as a root memory 406, external shared memory 410 can run at a slower speed (resulting in a higher data latency and a lower memory bandwidth). But this latency factor has less impact on the speed at which the tree analysis process is executed because these higher tree branches are not traversed as frequently. The use of internal memory and external memory allows each to be accessed in parallel by a pipelined processor. Also, use of the internal memory without external memory reduces the pin-out count of the integrated circuit incorporating the processor. Additionally, in applications that do not need external memory for storing higher levels of the tree, the external memory does not need to be populated. This reduces the system implementation cost.

Furthermore, depending on the structure of the particular tree, many of the pattern matching processes may terminate successfully at a lower level branch in the on-chip memory, and thereby avoid traversing the upper level branches stored in the slower memory.

In yet another embodiment, it is possible to store especially critical or frequently-used small trees entirely within the internal memory elements (406 alone, or 406 and 408), thus providing especially rapid tree processing for any tree that is located entirely on-chip. The segregation between the tree levels stored within the internal memories and the external memory can also be made on the basis of the probabilities of certain patterns in the input data.

Typically, the data input to a network processor using a tree characterization process is characterized according to several different attributes. There will therefore be a corresponding number of trees through which segments of the data packet or data block are processed to perform the characterization function. Accordingly, the lower level branches are stored on-chip and the higher-level branches are stored off-chip. To perform the multiple characterizations, a pipelined processor will access a lower branch of a tree stored in one of the on-chip memories and then move to the off-chip memory as the tree analysis progresses. But since the off-chip access time is longer, while waiting to complete the read cycle off-chip, the processor can begin to characterize other input data or begin another processing thread. In this way, several simultaneous tree analyses can be performed by the processor, taking advantage of the faster on-chip access speeds while waiting for a response from a slower off-chip memory.

In another embodiment, certain portions of the tree (not necessarily an entire tree level) are stored within different memory elements. For example, the most frequently traversed paths can be stored in a fast on-chip or local memory and the less-frequently traversed paths stored in a slower remote or external memory.

A tree structure may also be adaptable to changing system configurations. Assume that the tree is processing a plurality of TCP/IP addresses. When the process begins the tree is empty and therefore all of the input addresses default to the same output address. The tree process begins at the root and immediately proceeds to the default output address at the single leaf. Then, an intermediate instruction or decision node is added to direct certain input addresses to a first output address and all others to the default address. As more output addresses are added, the tree becomes deeper, i.e., having more branches or decision nodes. Accordingly, the growth of the tree can occur in both the local and the remote memory elements.

Although illustrative embodiments of the present invention have been described herein with reference to the accompanying drawings, it is to be understood that the invention is not limited to those precise embodiments, and that various other changes and modifications may be made by one skilled in the art without departing from the scope or spirit of the invention.

What is claimed is:

1. A method of performing a traversal of a tree structure, the method comprising the steps of:
storing a first portion of data of a tree structure to be traversed in a first memory level;
storing a second portion of data of the tree structure to be traversed in a second memory level;
storing at least a third portion of data of the tree structure to be traversed in at least a third memory level; and
in response to receipt of an input search object, a processor traversing one or more of the portions of the tree structure respectively stored in the memory levels to determine one or more matches between the tree data stored in the memory levels and the input search object;
wherein the processor, the first memory level, and the second memory level are implemented on one integrated circuit, and the third memory level is implemented external to the integrated circuit.

2. The method of claim 1, wherein the processor comprises two or more engines, and the first memory level comprises two or more memory elements, wherein the two or more memory elements are respectively dedicated to the two or more engines.

3. The method of claim 2, wherein the step of storing the first portion of the tree structure in the first memory level comprises storing a copy of the first portion of data of the tree structure in each of the two or more memory elements of the first memory level.

4. The method of claim 3, wherein a first one of the two or more engines accesses one or more of the portions of the tree structure respectively stored in the memory levels, including its dedicated memory element associated with the first memory level, to determine one or more matches between the stored tree data and at least a portion of the input search object.

5. The method of claim 4, wherein, substantially simultaneous with the first one of the engines, a second one of the two or more engines accesses one or more of the portions of the tree structure respectively stored in the memory levels, including its dedicated memory element associated with the first memory level, to determine one or more matches between the stored tree data and at least a portion of the input search object.

6. The method of claim 5, wherein the portion of the input search object processed by the first engine is different than the portion of the input search object processed by the second engine.

7. The method of claim 5, wherein the portion of the input search object processed by the first engine is the same as the portion of the input search object processed by the second engine.

8. The method of claim 4, wherein, substantially simultaneous with the first one of the engines, a second one of the two or more engines accesses one or more of the portions of the tree structure respectively stored in the memory levels, including its dedicated memory element associated with the first memory level, to determine one or more matches between the stored tree data and another input search object.

9. The method of claim 1, wherein an access time associated with the first memory level is less than an access time associated with at least one of the other memory levels.

10. The method of claim 1, wherein an access time associated with the third memory level is greater than an access time associated with at least one of the other memory levels.

11. The method of claim 1, wherein the processor comprises a network processor.

12. The method of claim 10, wherein the input search object comprises packet data.

13. The method of claim 11, wherein the tree structure comprises data used for classifying at least a portion of the packet data.

14. Apparatus for performing a traversal of a tree structure, comprising:
a first memory level for storing a first portion of data of a tree structure to be traversed;
a second memory level for storing a second portion of data of the tree structure to be traversed;
at least a third memory level for storing at least a third portion of data of the tree structure to be traversed; and
a processor for traversing, in response to receipt of an input search object, one or more of the portions of the tree structure respectively stored in the memory levels to determine one or more matches between the tree data stored in the memory levels and the input search object;
wherein the processor, the first memory level, and the second memory level are implemented on one integrated circuit, and the third memory level is implemented external to the integrated circuit.

15. The apparatus of claim 14, wherein the processor comprises two or more engines, and the first memory level comprises two or more memory elements, wherein the two or more memory elements are respectively dedicated to the two or more engines.

16. The apparatus of claim 15, wherein the step of storing the first portion of the tree structure in the first memory level comprises storing a copy of the first portion of data of the tree structure in each of the two or more memory elements of the first memory level.

17. The apparatus of claim 14, wherein an access time associated with the first memory level is less than an access time associated with at least one of the other memory levels.

18. The apparatus of claim 14, wherein an access time associated with the third memory level is greater than an access time associated with at least one of the other memory levels.

19. The apparatus of claim 14, wherein the processor comprises a network processor, the input search object comprises packet data, and the tree structure comprises data used for classifying at least a portion of the packet data.

20. An integrated circuit, comprising:
a first memory level for storing a first portion of data of a tree structure to be traversed;
a second memory level for storing a second portion of data of the tree structure to be traversed; and
a processor, wherein the processor is configured to access the first memory level, the second memory level, and at least a third memory level for storing at least a third portion of data of the tree structure to be traversed, wherein the third memory level is remote from the integrated circuit;
wherein, in response to receipt of an input search object, the processor traverses one or more of the portions of the tree structure respectively stored in the memory levels to determine one or more matches between the tree data stored in the memory levels and the input search object.
